(19) United States
(12) Patent Application Publication
(10) Pub. No.: US 2010/0139615 A1
(43) Pub. Date: Jun. 10, 2010

(54) DIRECT INJECTION FLATHEAD ENGINE

(76) Inventors: Chandan Mahato, Columbus, IN (US); Paulius V. Puzinauskas, Tuscaloosa, AL (US); Kenneth C. Midkiff, Tuscaloosa, AL (US)

Correspondence Address: Ballard Spahr LLP, SUITE 1000, 999 PEACHTREE STREET, ATLANTA, GA, 30309-3915, US

(21) Appl. No.: 12/525,248

(22) PCT Filed: Feb. 13, 2008
(86) PCT No.: PCT/US08/53853

§ 371 Date: Feb. 2, 2010

Related U.S. Application Data
(60) Provisional application No. 60/889,678, filed on Feb. 13, 2007.

(51) Int. Cl. F02B 5/02

(52) U.S. Cl. 123/305

(57) ABSTRACT

A direct injection flathead engine comprising an internal combustion cylinder block with at least one fuel injector positioned substantially transverse to the cylinder axis. The engine also comprises at least one exhaust valve positioned substantially near the at least one fuel injector, where the exhaust valve is on the same side of the piston as the fuel injector. In one aspect, a fuel injector is positioned substantially transverse to the cylinder axis, whereby a substantial portion of the fuel may be sprayed on top of the hot exhaust valve and deflected towards the spark plug, thus forming a stratified charge around the spark plug.

### CROSS-REFERENCE TO RELATED APPLICATIONS

This application claims benefit of U.S. Provisional Application No. 60/889,678, filed Feb. 13, 2007, which is hereby incorporated herein by reference in its entirety.

### FIELD OF THE INVENTION

The present invention relates to an internal combustion engine. More specifically, the invention relates to a direct injection flathead engine.

### BACKGROUND OF THE INVENTION

The term flathead engine refers to an internal combustion engine with valves placed in the cylinder block beside the piston, instead of in the cylinder head, as in an overhead valve engine. The design was common on early engine designs, but has since fallen from use.

Generally the flathead uses a small chamber on one side of the cylinder to carry the valves. This has a number of advantages, primarily making the cylinder head much simpler. It also means a valve can be operated by pushing directly up on it, as opposed to needing some sort of mechanical arrangement to push it down or to drive overhead cams, as on a “valve-in-head” engine. It may also lead to slightly easier cooling, as valve and pushrods are out of the way of the cylinder, making a cooling jacket simpler to construct.

The advantage of the flathead engine lies in its simplicity of design. There are fewer moving parts as compared to conventional over-head valve (“OHV”) engines. This not only makes it very simple and relatively inexpensive to manufacture, but also reduces maintenance costs. The flathead engine was discontinued despite these advantages, mainly because of poor emissions characteristics. In conventional stoichiometric flathead spark ignited engines, the fuel is premixed with air outside the engine. This air-fuel mixture is then inducted into the engine and combusted inside the combustion chamber. The flathead engine typically has a long combustion chamber, in which the spark plug is located at one end. The flame initiated at the spark plug sometimes gets quenched at the cold walls before it can reach the other end of the combustion chamber. This leads to unburned hydrocarbon (“UHC”) emissions.

The direct injection spark ignited engines were developed in the early 1900s' and were known as the Hesselman engines. In the early days the technology for high pressure gasoline injection was not developed enough to handle the low lubricity of gasoline. With major advancement in the area of high pressure fuel injection, direct injection gasoline engine technology is being revisited. A large number of automotive manufacturers have already come out with direct injection gasoline engine powered production vehicles, all of them based on OHV engine design. The basic idea behind the direct injection gasoline engine is charge stratification. Instead of premixing the fuel and air outside the engine as in conventional stoichiometric spark ignited gasoline engines, gasoline is directly injected into the combustion chamber. The gasoline spray is aimed at a cavity on top of the piston which deflects the fuel spray towards the spark plug, thus forming a localized cloud of rich air-fuel mixture around the spark plug. This is known as charge stratification. This stratified charge is easily ignited by the spark plug. Thus, although the air-fuel ratio is rich near the spark plug, the overall air-fuel ratio is lean. The deflection of the fuel spray from the top of the piston crown causes a thin film of fuel to form on the piston surface. This is called wall wetting and due to the cooler piston temperature it is difficult to vaporize this fuel film in time to take part in combustion. This is one major source of UHC emissions.

What is needed is an engine with the benefits of the flathead engine, that does not have the negative emissions characteristics nor problems with efficiency.

### SUMMARY OF THE INVENTION

The present invention relates to a direct injection flathead engine. In one aspect of the invention, the flathead engine comprises an internal combustion cylinder block comprising at least one fuel injector positioned substantially transverse to the cylinder axis A_{c}. The engine also comprises at least one exhaust valve positioned substantially near the at least one fuel injector, where the exhaust valve is on the same side of the piston as the fuel injector.

In one aspect, a fuel injector is positioned substantially transverse to the cylinder axis A_{c}, whereby a substantial portion of the fuel may be sprayed on top of the hot exhaust valve and deflected towards the spark plug, thus forming a stratified charge around the spark plug. This helps to minimize the formation of fuel film and largely helps in fuel vaporization and better combustion, thereby reducing UHC emissions. This tends to alleviate the emissions problem experienced in OHV direct injection gasoline engines and still enjoy the advantage of better engine performance at higher fuel economy.

These and other objects of the present invention will be clear when taken in view of the detailed specification and disclosure in conjunction with the appended figures.

### DETAILED DESCRIPTION OF THE DRAWINGS

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

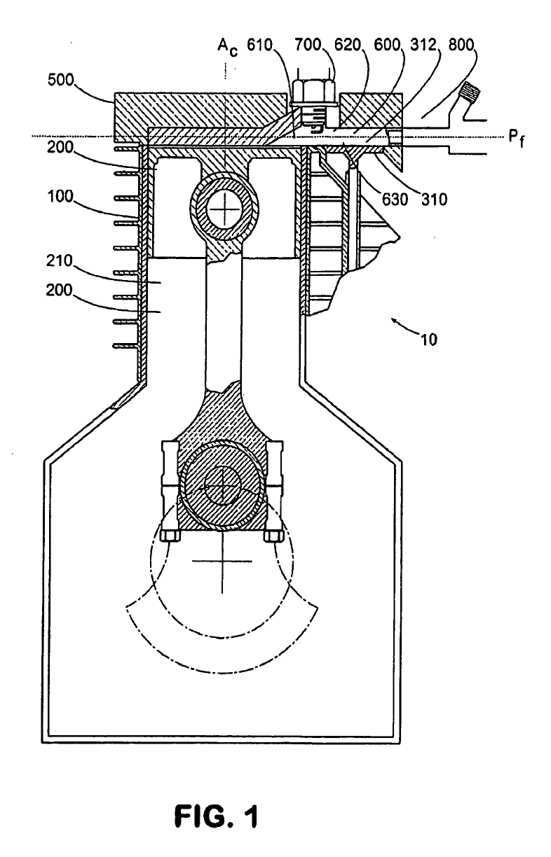

FIG. 1 is a cross-sectional view of the invention for direct fuel injection flathead engine, showing one aspect of the piston, fuel injector and spark plug arrangement;

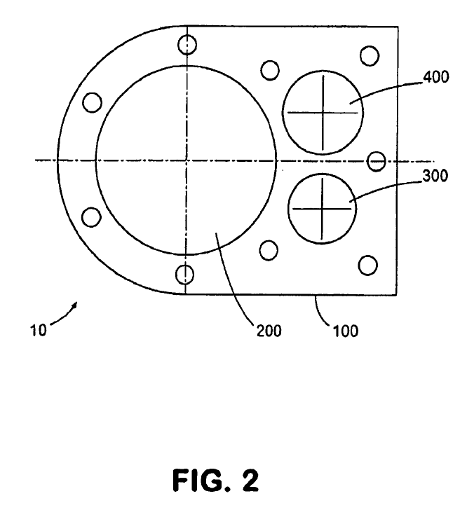

FIG. 2 is the top plan view of the cylinder block of the flathead engine of FIG. 1;

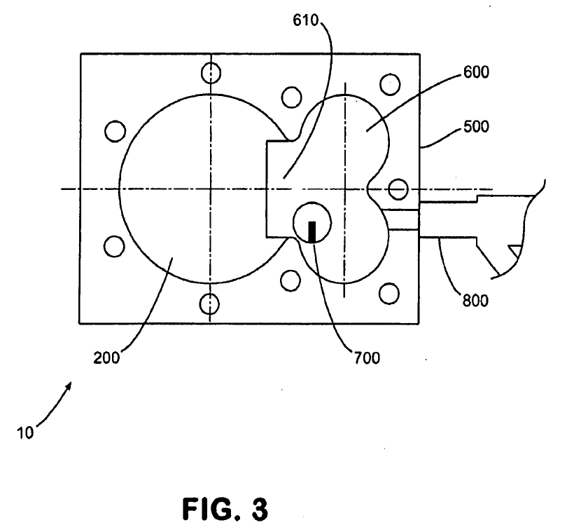

FIG. 3 is the bottom plan view of the cylinder head of the flathead engine of FIG. 1.

### DETAILED DESCRIPTION OF THE INVENTION

The present invention may be understood more readily by reference to the following detailed description of the invention and the Examples included therein and to the Figures and their previous and following description.

Before the present systems, articles, devices, and/or methods are disclosed and described, it is to be understood that this invention is not limited to specific systems, specific devices, or to particular methodology, as such may, of course, vary. It is also to be understood that the terminology used herein is for the purpose of describing particular embodiments only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used in the specification and the appended claims, the singular forms “a,” “an” and “the” include plural referents unless the context clearly dictates otherwise. Thus, for example, reference to “a fuel injector” includes two or more such fuel injectors, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

“Optional” or “optionally” means that the subsequently described event or circumstance may or may not occur, and that the description includes instances where said event or circumstance occurs and instances where it does not.

The present invention relates to a direct injection flathead engine. In one aspect of the invention, the flathead engine comprises an internal combustion cylinder block 100 that has at least one cylinder 200 defining an interior cavity 210. The cylinder block 100 also defines an exhaust port 300 and an intake port 400 adjacent to the cylinder 200 on a first side of the cylinder block. The exhaust port 300 has an exhaust valve 310 disposed therein, and the intake port 400 has an intake valve 410 disposed therein.

In one aspect, the direct fuel injection flathead engine also comprises a cylinder head 500 substantially covering the cylinder block. In another aspect, the engine comprises a combustion chamber 600 that is defined by portions of the cylinder head 500, the cylinder block 100, and the top faces 312, 412 of the exhaust and intake valves. In this aspect, the distal end 610 of the combustion chamber 600 is in fluid communication with a portion of the interior cavity 210 of the cylinder.

In another aspect, the engine also comprises an ignition device 700 at least partially disposed therein the cylinder head and in communication with a portion of the combustion chamber. As one skilled in the art can appreciate, the ignition device 700 may be, for example and not meant to be limiting, a conventional spark plug, or similar spark-producing device.

In yet another aspect, the engine comprises at least one fuel injector 800 positioned in a fuel injector plane P_{f} substantially transverse to the cylinder axis A_{c}. The at least one fuel injector 800 is configured to inject fuel into the combustion chamber substantially toward the ignition device. By “toward,” it is meant that the fuel injector injects fuel in the general direction of the ignition device such that at least a portion of the fuel comes in close proximity to the spark

In one aspect of the invention, the exhaust valve is configured to move between a closed position and an open position, where, in the closed position, at least a portion of the top face of the exhaust valve 310 protrudes into the combustion chamber 600. The same may be true for the intake valve 410. In another aspect, the fuel injector plane P_{f} bisects the combustion chamber into an upper portion and a lower portion. In this aspect, the ignition device 700 is positioned in the upper portion 620 of the combustion chamber 600 and the exhaust valve is positioned in the lower portion 630 of the combustion chamber. In use, a substantial portion of the fuel may be sprayed from the fuel injector 800 on top of the hot exhaust valve 310 and deflected towards the ignition device 700, thus forming a stratified charge around the ignition device. This helps to minimize the formation of fuel film and largely helps in fuel vaporization and better combustion, thereby reducing UHC emissions. This also tends to alleviate the emissions problem experienced in OHV direct injection gasoline engines and still enjoys the advantage of better engine performance at higher fuel economy.

One aspect of the cross sectional arrangement of flathead engine is shown in FIG. 1. In this aspect, the fuel would be injected into the combustion chamber 600 as the piston 220 moves towards top dead center (“TDC”). The ignition device 700, which may be positioned substantially over the exhaust valve 310, as described herein above, fires after the fuel is injected into the combustion chamber.

In one aspect, the cylinder block 100 and the cylinder head 500 can be air cooled. In another aspect, the cylinder head can be liquid cooled. As one skilled in the art will appreciate any conventional cooling system will be used as appropriate and usually depends on the size and application of the engine.

In another aspect, a conical spray pattern single hole fuel injector 800 may be used. In this aspect, high pressure fuel is delivered to the injector inlet 8 through a high pressure fuel pump, driven directly by the engine. In yet another aspect, a slit nozzle injector may be used in lieu of the conical spray injector. The nozzle plane may be substantially parallel to the cylinder axis. In still another aspect, an air-assisted fuel injector may be used. The injection of air along with fuel increases the volumetric efficiency of the engine and increases the turbulence inside the combustion chamber, which results in more complete combustion.

In still another aspect, the fuel injector 800 may be placed over the exhaust valve and directed towards the intake valve. The fuel injector may also be placed over the intake valve and directed towards the exhaust valve. In this aspect, the ignition device 700 may be located over the exhaust valve 310 or the intake valve. As one skilled in the art can appreciate, more than one ignition device may be present. For example, and not meant to be limiting, there may be a ignition device 700 positioned over the exhaust valve and one over the intake valve.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims.

Moreover, although specific terms are employed herein, as well as in the claims which follow, they are used only in a generic and descriptive sense, and not for the purposes of limiting the described invention, nor the claims which follow.

What is claimed is:

1. A direct fuel injected flathead engine comprising:
a cylinder block comprising at least one cylinder defining an interior cavity and having a longitudinal cylinder axis, wherein the cylinder block defines an exhaust port and an intake port adjacent to the at least one cylinder and on a first side of the cylinder block;
an intake valve having a top face and being disposed therein the intake port;
an exhaust valve having a top face and being disposed therein the exhaust port;
a cylinder head substantially covering the cylinder block;
a combustion chamber defined by portions of the cylinder head, the cylinder block, the top face of the intake valve, and the top face of the exhaust valve, the combustion chamber having a proximal end and an opposed distal end, wherein the distal end of the combustion chamber is in fluid communication with a portion of the interior cavity of the cylinder;
an ignition device at least partially disposed therein the cylinder head and in communication with a portion of the combustion chamber; and
a fuel injector positioned in a fuel injector plane substantially transverse to the cylinder axis, wherein the fuel injector is configured to inject fuel into the combustion chamber substantially toward the ignition device.

2. The direct fuel injected flathead engine of claim 1, wherein the exhaust valve is configured to move between a closed position and an open position, and wherein, in the closed position, at least a portion of the top face of the exhaust valve protrudes into the combustion chamber.

3. The direct fuel injected flathead engine of claim 2, wherein the fuel injector plane bisects the combustion chamber into an upper portion and a lower portion; and wherein the ignition device is positioned in the upper portion of the combustion chamber and the exhaust valve is positioned in the lower portion of the combustion chamber.

4. The direct injected flathead engine of claim 3, wherein, in use, at least a portion of the fuel from the fuel injector deflects off of a portion of the top face of the exhaust valve and is directed upward and toward the ignition device.

5. The direct fuel injected flathead engine of claim 1, wherein the intake valve is configured to move between a closed position and an open position, and wherein, in the closed position, at least a portion of the top face of the intake valve protrudes into the combustion chamber.

6. The direct fuel injected flathead engine of claim 5, wherein the fuel injector plane bisects the combustion chamber into an upper portion and a lower portion; and wherein the ignition device is positioned in the upper portion of the combustion chamber and the intake valve is positioned in the lower portion of the combustion chamber.

7. The direct injected flathead engine of claim 6, wherein, in use, at least a portion of the fuel from the fuel injector deflects off of a portion of the top face of the intake valve and is directed upward and toward the ignition device.

8. The direct injection flathead engine of claim 1, wherein the ignition device is a spark plug.

9. The direct injection flathead engine of claim 1, wherein the fuel injector is a conical spray injector.

10. The direct injection flathead engine of claim 1, wherein the fuel injector is a slit nozzle injector defining a slit for egress of fuel.

11. The direct injection flathead engine of claim 10, wherein the slit is substantially parallel to the cylinder axis.

12. The direct injection flathead engine of claim 1, wherein the fuel injector is an air assisted fuel injector.

13. A direct fuel injected flathead engine comprising:
a cylinder block comprising at least one cylinder defining an interior cavity and having a longitudinal cylinder axis, wherein the cylinder block defines an exhaust port and an intake port adjacent to the at least one cylinder and on a first side of the cylinder block;
an intake valve having a top face and being disposed therein the intake port;
an exhaust valve having a top face and being disposed therein the exhaust port;
a cylinder head substantially covering the cylinder block;
a combustion chamber positioned on the first side of the cylinder axis defined by at least portions of the cylinder head, the cylinder block, the top face of the intake valve, and the top face of the exhaust valve, the combustion chamber having a proximal end and an opposed distal end that is in fluid communication with a portion of the interior cavity of the cylinder;
a plurality of ignition devices at least partially disposed therein the cylinder head and in communication with a portion of the combustion chamber; and
a fuel injector positioned in a fuel injector plane substantially transverse to the cylinder axis the fuel injector configured to inject fuel into the combustion chamber substantially toward the plurality of ignition devices.

14. The direct fuel injected flathead engine of claim 13, wherein the exhaust valve is configured to move between a closed position and an open position, and wherein, in the closed position, at least a portion of the top face of the exhaust valve protrudes into to the combustion chamber.

15. The direct fuel injected flathead engine of claim 14, wherein the fuel injector plane bisects the combustion chamber into an upper portion and a lower portion; and wherein the ignition device is positioned in the upper portion of the combustion chamber and the exhaust valve is positioned in the lower portion of the combustion chamber.

16. The direct injected flathead engine of claim 15, wherein, in use, the fuel from the fuel injector deflects off of a portion of the top face of the exhaust valve and is directed upward and toward the pair of ignition devices.

17. The direct fuel injected flathead engine of claim 13, wherein the intake valve is configured to move between a closed position and an open position, and wherein, in the closed position, at least a portion of the intake valve protrudes into to the combustion chamber.

18. The direct fuel injected flathead engine of claim 17, wherein the fuel injector plane bisects the combustion chamber into an upper portion and a lower portion; and wherein the ignition device is positioned in the upper portion of the combustion chamber and the intake valve is positioned in the lower portion of the combustion chamber.

19. The direct injected flathead engine of claim 18, wherein, in use, the fuel from the fuel injector deflects off of a portion of the top face of the intake valve and is directed upward and toward the plurality of ignition devices.

20. The direct injection flathead engine of claim 13, wherein each ignition device of the plurality of ignition devices is a spark plug.

21. The direct injection flathead engine of claim 13, wherein the fuel injector is a conical spray injector.

22. The direct injection flathead engine of claim 13, wherein the fuel injector is a slit nozzle injector defining a slit for egress of fuel.

23. The direct injection flathead engine of claim 22, wherein the slit is substantially parallel to the cylinder axis.

24. The direct injection flathead engine of claim 13, wherein the fuel injector is an air assisted fuel injector.

25. The direct injection flathead engine of claim 13, wherein the plurality of ignition devices comprises a pair of ignition devices.
